(19) United States
(12) Patent Application Publication
(10) Pub. No.: US 2026/0361875 A1
(43) Pub. Date: Nov. 12, 2026

(54) Method and Apparatus of Sign Prediction for Block Vector Difference in Intra Block Copy

(71) Applicant: MEDIATEK INC., Hsinchu City (TW)

(72) Inventors: Chen-Yen LAI, Hsinchu City (TW); Ching-Yeh CHEN, Hsinchu City (TW); Tzu-Der CHUANG, Hsinchu City (TW)

(21) Appl. No.: 19/123,893

(22) PCT Filed: Oct. 9, 2023
(86) PCT No.: PCT/CN2023/123522

§ 371 Date: Apr. 24, 2025

Related U.S. Application Data
(60) Provisional application No. 63/380,966, filed on Oct. 26, 2022.

(51) Int. Cl. H04N 19/129; H04N 19/105; H04N 19/176

(52) U.S. Cl. CPC H04N 19/129; H04N 19/105; H04N 19/176

(57) ABSTRACT

A method and apparatus for BVP/MVP sign prediction. According to this method, a BVP/MVP is determined. Absolute x-component and y-component values for a BVD/MVD are determined. A set of candidate BVs/MVs is determined based on the BVP/MVP combined with the absolute x-component and y-component values for the BVD/MVD and possible sign combinations. A set of reference blocks corresponding to the set of candidate BVs or candidate MVs is determined, wherein a member reference block is set as an invalid reference block if any sample of the member reference block or any sample of a template of the member reference block is outside an available region. A target reference block from the set of reference blocks, which is reordered according to template costs, is determined. True sign for the BVD or the MVD is determined based on a reordered set of reference blocks.

### CROSS REFERENCE TO RELATED APPLICATIONS

The present invention is a non-Provisional Application of and claims priority to U.S. Provisional Patent Application No. 63/380,966, filed on Oct. 26, 2022. The U.S. Provisional Patent Applications are hereby incorporated by reference in their entireties.

### FIELD OF THE INVENTION

The present invention relates to video coding using the Intra Block Copy (IBC) coding tool. In particular, the present invention discloses a scheme to constrain available region for block vector prediction/motion vector prediction to improve the coding performance.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

### IBC Mode

Current picture referencing (CPR) or Intra block copy (IBC) has been proposed during the standardization of HEVC SCC (Screen Content Coding) extensions. It has been proved to be efficient for coding screen content video materials. The IBC operation is very similar to original Inter mode in video codec. However, the reference picture is the current decoded frame instead of previously coded frames.

The IBC coding mode requires reference samples from the current picture. In particular, the IBC coding of a current block often requires reference samples immediately above or to the left of the current block. For a block coded in the IBC mode, a vector (name Block Vector BV) is determined to point to a reference block in the current picture. The predicted difference is coded. Furthermore, similar to inter prediction, the BV associated with the current block is coded using a BV predictor (BVP).

The IBC mode is also adopted by the VVC coding standard with some modifications and improvements. The VVC IBC is also carried into the recent development of next generation video coding ECM6 (Muhammed Coban, et al., “Algorithm description of Enhanced Compression Model 6 (ECM 6)”, Joint Video Exploration Team (JVET) of ITU-T SG 16 WP 3 and ISO/IEC JTC 1/SC 29/WG 11, 27th Meeting, by teleconference, 13-22 Jul. 2022, Document JVET-AA2025). In ECM6.0, signs of block vector difference (BVD) in IBC blocks are transmitted with equal probability (EP) and signs of motion vector difference (MVD) in INTER blocks are coded by MVD sign prediction.

### Block Vector Difference Sign Prediction (BVDSP)

In JVET-AB0095 (Junyan Huo, et al., “Non-EE2: Block Vector Difference Sign Prediction (BVDSP) for IBC blocks”, Joint Video Exploration Team (JVET) of ITU-T SG 16 WP 3 and ISO/IEC JTC 1/SC 29/WG 11, 28th Meeting, Mainz, DE, 20-28 Oct. 2022, Document JVET-AB0095), the block vector difference sign prediction (BVDSP) is proposed to improve coding efficiency.

Block vector difference sign prediction (BVDSP) can be applied for IBC blocks when the block vector difference contains non-zero component. Possible BVD sign combinations are sorted according to template matching cost, and index corresponding to the true BVD sign is derived and coded with a context model. At the decoder side, the BVD signs are derived as following major steps:
Step 1: 4 candidate BVs are derived according to BVP (BVP=(BVP[0], BVP[1])) and combinations between possible signs and absolute BVD (BVD=(BVD[0], B VD[1])):

(BVP[0]+absBVD[0], BVP[1]+absBVD[1]),

(BVP[0]+absBVD[0], BVP[1]−absBVD[1]),

(BVP[0]−absBVD[0], BVP[1]+absBVD[1]),

(BVP[0]−absBVD[0], BVP[1]−absBVD[1]).
Step 2: Derive prediction costs of 4 candidate BVs based on template matching and sort them according to the costs.
Step 3: Use BVDSP index to select the true BVD sign.
Step 4: Add the true BVD to the BVP to get the final BV.

Bilinear filter is used in reference template generation. The template matching cost is measured by the SAD (Sum of Absolute Differences) between the neighbouring samples in the template of the current CU and their corresponding reference samples in the template of a corresponding reference block, as illustrated in FIG. 2, where an example of BVDSP for a current IBC-coded PU 210 in the current picture 220 is shown and the BVP 230 of PU 210 points to a location 232 in the current picture. The location of a current PU 210 is identified by the upper-left corner location 212 as shown in FIG. 2. The x-and y-components of BVD are both non-zero in this example. The locations of 4 possible candidate BVs corresponding to 4 possible sign combinations are shown as dots 240, 242, 244 and 246 respectively. Each of these 4 locations identifies the upper-left location of a corresponding reference block for IBC. The templates for the current block and the 4 candidate reference blocks are shown by the L-shape areas on the top and left of the respective blocks. In FIG. 2, the template matching cost for each candidate reference block is measured using reference samples in the corresponding templates. For example, the template cost for the reference block at location 240 is determined using the L-shaped template at location 240 and the L-shaped template at location 212 (i.e., the current block).

In general case, 4 BVD candidates are evaluated (±|BVD[0], ±|BVD[1]). If one of BVD components (x or y) is zero, only 2 BVD candidates are possible. In the case when all BVD components are zero, no sign derivation is needed.

In the present invention, a constrained available region for BVP in BVDSP or similar applications is disclosed to improve the coding performance.

### BRIEF SUMMARY OF THE INVENTION

A method and apparatus for video coding using constrained available region for BVP/MVP sign prediction are disclosed. According to this method, input data associated with a current block are received, wherein the input data comprise pixel data to be encoded at an encoder side or coded data associated with the current block to be decoded at a decoder side. A block vector predictor (BVP) or a motion vector predictor (MVP) is determined. Absolute x-component value and absolute y-component value for a block vector difference (BVD) or a motion vector difference (MVD) are determined, wherein at least one of the absolute x-component value and the absolute y-component value is non-zero. A set of candidate BVs (block vectors) or candidate MVs (motion vectors) is determined based on the BVP or the MVP combined with the absolute x-component value and the absolute y-component value for the BVD or the MVD and with possible sign combinations for the BVD or the MVD. A set of reference blocks corresponding to the set of candidate BVs or candidate MVs is determined, wherein a member reference block is set as an invalid reference block if any sample of the member reference block or any sample of a template of the member reference block is outside an available region. A target reference block from the set of reference blocks is determined, wherein the set of reference blocks is reordered according to template costs of the set of reference blocks and any invalid reference block is excluded from the set of reference blocks or a high template cost is assigned to said any invalid reference block. True sign for the BVD or the MVD is determined based on a reordered set of reference blocks.

In one embodiment, the available region is pre-defined. In one embodiment, the available region is related to a picture boundary, subpicture boundary, slice boundary or tile boundary. In another embodiment, the available region is related to CTU boundary, VPDU boundary, CTU row boundary, or processing unit boundary. In another embodiment, the available region excludes the current block. In another embodiment, the available region excludes a part of not-yet encoded or decoded region. In another embodiment, the available region excludes a part of already encoded or decoded region.

In one embodiment, the method is applied to a coding tool utilising a template matching scheme or a bilateral matching scheme. In one embodiment, the coding tool corresponds to regular merge candidate list, BM merge candidate list, or affine candidate list, IBC merge candidate list, MVP candidate list, IBC MVP candidate list.

In one embodiment, the method comprises reordering the template costs for the set of reference blocks.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates an example of Block Vector Difference Sign Prediction (BVDSP) process.

FIG. 3 illustrates a flowchart of an exemplary video coding system that constrains available region for Block Vector Difference Sign Prediction (BVDSP) according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In the present invention, constrained available region for Block Vector Difference Sign Prediction (BVDSP)is disclosed to improve the performance of ALF.

To improve coding efficiency of block vector difference sign prediction (BVDSP), the present invention proposes to constrain the available region for BVP. In one embodiment, an available region is pre-defined, and if a reference block (pointed by a particular sign value of BVD) or the generated template of a reference block has at least one sample outside the available region, this reference block (corresponding to this BVD's sign pair) is treated as invalid. For example, even we can have the template of a possible sign pair of a block, but if that block has some samples that are not available, the corresponding TM cost should be set to a predefined high cost value (e.g. maximum cost value) so that the candidate will have no chance to be selected due to the high cost value. Accordingly, the TM calculation of the invalid candidate will be skipped.

The proposed method not only can be applied to BVD sign prediction, but also be applied to any template-matching related BV or BV cost derivation. For example, the BV merge candidate list reordering with template-matching can set the BV candidate or BV+offset candidate as non-available or set the cost of the BV candidate or BV+offset candidate to a pre-defined high cost if the reference block or the template pointed by the BV candidate or BV+offset candidate covers at least one non-available sample.

The pre-defined available region can be related to a picture boundary, subpicture boundary, slice/tile boundary. The pre-defined available region can also be related to CTU boundary (e.g. current CTU and left CTU), VPDU (Virtual Pipeline Decoding Unit) boundary, CTU row boundary, or processing unit boundary. The non-available region of IBC may contain the current block. In other words, the current block may be excluded from the available region. The non-available region of IBC can also contain the regions that are not encoded/decoded yet. In other words, at least a part of not-yet encoded/decoded region of the current block may be excluded from the available region. The non-available region of IBC can also contain the regions that have been already encoded/decoded (i.e., at least a part of not-yet encoded/decoded region of the current block being excluded from the available region), but set as not available with some rule, such as the way HEVC-SCC does.

In another embodiment, the above motioned method can be applied to any tool using template matching for candidate list reordering. For example, the above motioned method can be applied to any of the following tools using template matching for candidate list reordering, such as regular merge candidate list, BM (Bilateral Matching) merge candidate list, or affine candidate list, IBC merge candidate list, MVP candidate list, IBC MVP candidate list.

The proposed method can also be applied to the inter mode that uses template matching or bilateral matching. When doing the template matching or bilateral matching, if the reference samples for matching or the target block of the template contains one of the samples that is not available, the matching cost is set to a predefined value (e.g. max_value). The samples outside the picture boundary, outside the padding region of the picture boundary, or outside a determined search region will be treated as not available. In another embodiment, if one of the sample is non-available, the MV is clipped or modified to make all the samples are available.

In yet another embodiment, for MVD/BVD sign prediction, the final MV (MVP+MVD, or BVP+BVD) with a smaller value (or close to the collocated block) is set as higher priority. The template matching method can be replaced by this kind of location-based reordering for BVD/MVD sign prediction. Similarly, if the BV touches an unavailable sample, the BV will be set to the lowest priority (e.g. set the cost as max_cost). In another example, choosing a candidate having the larger or smaller value as high priority can depend on the context/content of the neighbouring information, some rule or some algorithm.

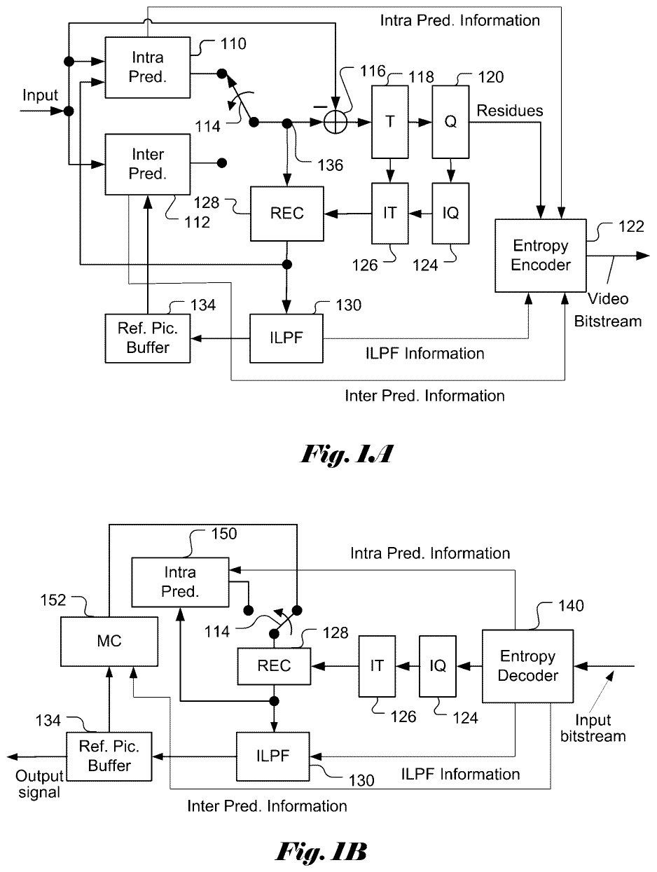

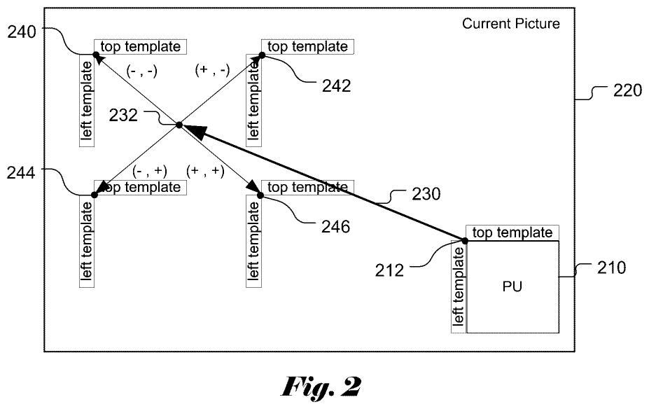

Any of the constrained region for BVP/MVP sign prediction as described above can be implemented in encoders and/or decoders. For example, any of the proposed methods can be implemented in intra and/or inter module (e.g. Intra Pred. 110/Inter Pred. 112 in FIG. 1A and/or Intra Pred. 150/MC 152 in FIG. 1B) of an encoder or a decoder. Alternatively, any of the proposed methods can be implemented as a circuit coupled to the intra/inter coding module of an encoder and/or the decoder. The methods may also be implemented using executable software or firmware codes stored on a media, such as hard disk or flash memory, for a CPU (Central Processing Unit) or programmable devices (e.g. DSP (Digital Signal Processor) or FPGA (Field Programmable Gate Array)).

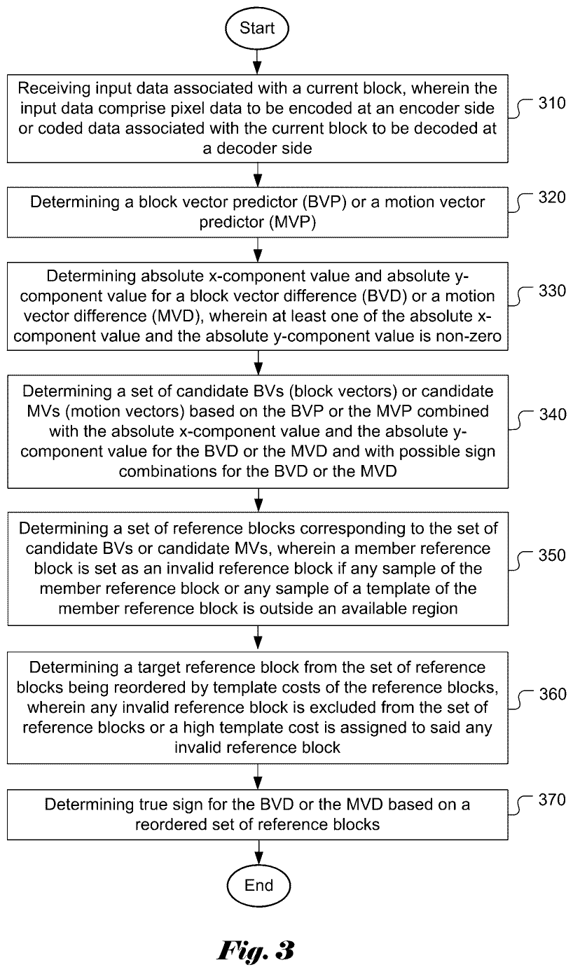

FIG. 3 illustrates a flowchart of an exemplary video coding system that constrains available region for Block Vector Difference Sign Prediction (BVDSP) according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block are received in step 310, wherein the input data comprise pixel data to be encoded at an encoder side or coded data associated with the current block to be decoded at a decoder side. A block vector predictor (BVP) or a motion vector predictor (MVP) is determined in step 320. Absolute x-component value and absolute y-component value for a block vector difference (BVD) or a motion vector difference (MVD) are determined in step 330, wherein at least one of the absolute x-component value and the absolute y-component value is non-zero. A set of candidate BVs (block vectors) or candidate MVs (motion vectors) is determined in step 340 based on the BVP or the MVP combined with the absolute x-component value and the absolute y-component value for the BVD or the MVD and with possible sign combinations for the BVD or the MVD. A set of reference blocks corresponding to the set of candidate BVs or candidate MVs is determined in step 350, wherein a member reference block is set as an invalid reference block if any sample of the member reference block or any sample of a template of the member reference block is outside an available region. A target reference block from the set of reference blocks is determined in step 360, wherein the set of reference blocks is reordered according to template costs of the set of reference blocks, and any invalid reference block is excluded from the set of reference blocks or a high template cost is assigned to said any invalid reference block. True sign for the BVD or the MVD is determined based on a reordered set of reference blocks in step 370.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprise pixel data to be encoded at an encoder side or coded data associated with the current block to be decoded at a decoder side;
determining a block vector predictor (BVP) or a motion vector predictor (MVP);
determining absolute x-component value and absolute y-component value for a block vector difference (BVD) or a motion vector difference (MVD), wherein at least one of the absolute x-component value and the absolute y-component value is non-zero;
determining a set of candidate BVs (block vectors) or candidate MVs (motion vectors) based on the BVP or the MVP combined with the absolute x-component value and the absolute y-component value for the BVD or the MVD and with possible sign combinations for the BVD or the MVD;
determining a set of reference blocks corresponding to the set of candidate BVs or candidate MVs, wherein a member reference block is set as an invalid reference block if any sample of the member reference block or any sample of a template of the member reference block is outside an available region;
determining a target reference block from the set of reference blocks being reordered by template costs of the reference blocks, wherein any invalid reference block is excluded from the set of reference blocks or a high template cost is assigned to said any invalid reference block; and
determining true sign for the BVD or the MVD based on a reordered set of reference blocks.

2. The method of claim 1, wherein the available region is pre-defined.

3. The method of claim 2, wherein the available region is related to a picture boundary, subpicture boundary, slice boundary or tile boundary.

4. The method of claim 2, wherein the available region is related to CTU boundary, VPDU boundary, CTU row boundary, or processing unit boundary.

5. The method of claim 2, wherein the available region excludes the current block.

6. The method of claim 2, wherein the available region excludes a part of not-yet encoded or decoded region.

7. The method of claim 2, wherein the available region excludes a part of already encoded or decoded region.

8. The method of claim 1, wherein the method is applied to a coding tool utilising a template matching scheme or a bilateral matching scheme.

9. The method of claim 8, wherein the coding tool corresponds to regular merge candidate list, BM merge candidate list, affine candidate list, IBC merge candidate list, MVP candidate list, or IBC MVP candidate list.

10. The method of claim 1, further comprising reordering the template costs for the set of reference blocks.

11. An apparatus of video coding, the apparatus comprising one or more electronics or processors arranged to:
receive input data associated with a current block, wherein the input data comprise pixel data to be encoded at an encoder side or coded data associated with the current block to be decoded at a decoder side;
determine a block vector predictor (BVP) or a motion vector predictor (MVP);
determining absolute x-component value and absolute y-component value for a block vector difference (BVD) or a motion vector difference (MVD), wherein at least one of the absolute x-component value and the absolute y-component value is non-zero;
determine a set of candidate BVs (block vectors) or candidate MVs (motion vectors) based on the BVP or the MVP combined with the absolute x-component value and the absolute y-component value for the BVD or the MVD and with possible sign combinations for the BVD or the MVD;
determine a set of reference blocks corresponding to the set of candidate BVs or candidate MVs, wherein a member reference block is set as an invalid reference block if any sample of the member reference block or any sample of a template of the member reference block is outside an available region;
determine a target reference block from the set of reference blocks being reordered by template costs of the reference blocks, wherein any invalid reference block is excluded from the set of reference blocks or a high template cost is assigned to said any invalid reference block; and
determine true sign for the BVD or the MVD based on a reordered set of reference blocks.
